(19) United States
(12) Patent Application Publication
(10) Pub. No.: US 2007/0229993 A1
(43) Pub. Date: Oct. 4, 2007

(54) COMPENSATING FOR A TELESCOPE'S OPTICAL ABERRATIONS USING A DEFORMABLE MIRROR

(76) Inventors: Hamid Hemmati, Encino, CA (US); Yijiang Chen, La Canada, CA (US)

Correspondence Address: Zilka-Kotab, PC, P.O. BOX 721120, SAN JOSE, CA, 95172-1120, US

(21) Appl. No.: 11/694,860

(22) Filed: Mar. 30, 2007

Related U.S. Application Data
(60) Provisional application No. 60/787,469, filed on Mar. 30, 2006.

(51) Int. Cl. G02B 5/08; G02B 7/182

(52) U.S. Cl. 359/846

(57) ABSTRACT

An optical system and associated method are provided. Included is at least one telescope. Further provided is a deformable mirror operable to compensate for optical aberrations resulting from the telescope.

### RELATED APPLICATION(S)

The present application claims the benefit of a provisional application filed on Mar. 30, 2006, under application Ser. No. 60/787,469, which is incorporated herein by reference in its entirety for all purposes.

### STATEMENT REGARDING FEDERALLY SPONSORED RESEARCH OR DEVELOPMENT

The invention described herein was made in the performance of work under a NASA contract, and is subject to the provisions of Public Law 96-517 (35 USC 202) in which the Contractor has elected to retain title.

### FIELD OF THE INVENTION

The present invention relates to optical systems, and more particularly to compensating for optical aberrations in the context of an optical system.

### BACKGROUND

Optical systems that are used for high-resolution imaging purposes typically require large aperture telescopes. In addition to such size requirement, these telescopes must also exhibit near diffraction-limited image quality that, in turn, significantly contributes to the cost of such telescopes. While such expense is justified for optical systems specifically used for imaging purposes, the foregoing quality requirements may be relaxed when designing optical systems for free-space laser communications, laser radar, and laser remote sensing purposes.

Thus, there is a need for designing lower-cost optical systems specifically adapted for accommodating communication by way of optical signals (e.g. lasers, etc.). While lower-cost telescopes are available for such purpose, the quality of such telescopes must exhibit at least a certain level of quality, albeit not as high as the quality found in imaging telescopes. There is thus a need for addressing these and/or other issues associated with the prior art.

There is also a need to actively compensate for both static and/or dynamic optical distortions. Static errors result primarily from manufacturing of optics and the opto-mechanical system (e.g. mirror cell). Dynamic aberrations stem from external sources, e.g. thermal variations due to the environment or sunlight entering the telescope or gravity sag when a telescope is actuated.

### SUMMARY

An optical system and associated method are provided. Included is a deformable mirror operable to compensate for optical aberrations resulting from a telescope. By using such deformable mirror in this manner, a reduction in cost (e.g. associated with the telescope, etc.) may be realized in some possible embodiments, while improving large-diameter optics wavefront quality. In various embodiments, an optical sensor (e.g. an array detector acting as a wavefront sensor, a single detector acting as a signal amplitude detector, etc.) may be provided for receiving an optical signal via the deformable mirror.

### BRIEF DESCRIPTION OF THE DRAWINGS

FIG. 1 illustrates an optical system capable of compensating for optical aberrations, in accordance with one embodiment.

FIG. 2 illustrates a single telescope optical system, in accordance with another embodiment.

FIG. 3 illustrates a multiple telescope optical system, in accordance with yet another embodiment.

### DETAILED DESCRIPTION

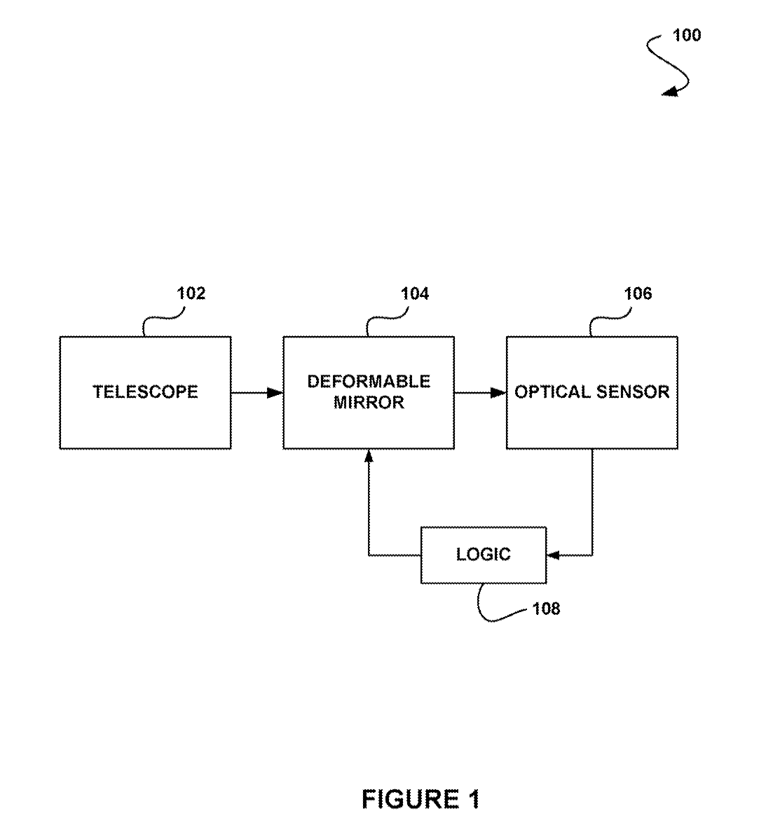

FIG. 1 illustrates an optical system 100 capable of compensating for optical aberrations, in accordance with one embodiment. As shown, included is at least one telescope 102 that receives or transmits an optical signal. While one telescope 102 is shown in FIG. 1, it should be noted that embodiments are contemplated where multiple telescopes or multiple optical systems are employed. Further, it should be noted that the techniques set forth herein are not necessarily limited to use with telescopes. Other embodiments are contemplated involving other types of optical systems as well. For example, such optical systems may be formed by any type of optical (e.g. reflective, refractive, diffractive, etc.) elements and/or electro-optical elements.

In one embodiment, the telescope 102 may include a large diameter primary mirror telescope 102. For example, in different embodiments, the telescope 102 may have a diameter that exceeds 1 meter (e.g. to greater tens of meters). Of course, other embodiments are contemplated where smaller diameters are employed.

During use, a beacon signal (not shown) may enter the telescope 102. Such beacon signal may include a portion of a communications signal, an artificially generated guide star, light from a star within a field-of-view of the telescope 102, light from a planet, and/or an artificial signal (e.g. laser, light-emitting-diode, etc.) placed outside the telescope 102 such that light generated by the artificial signal propagates through the telescope 102, for reasons that will soon become apparent. In various embodiments, the signal may include an optical frequency signal, an ultraviolet frequency signal, a near or far infrared frequency signal, a terahertz frequency signal, a millimeter-wave frequency signal, and/or a microwave frequency signal.

Further provided is at least one deformable mirror 104 operable to compensate for optical aberrations resulting from the telescope 102. In the present description, the deformable mirror 104 refers to any mirror that is capable of changing in form. Non-exhaustive examples of such deformable mirror 104 may include, but are certainly not limited to a segmented deformable mirror, continuous faceplate deformable mirror, membrane deformable mirror, liquid crystal deformable mirror, microelectromechanical systems (MEMS) deformable mirror, bimorph deformable mirror, micro-machined deformable mirror, piezoelectric-actuated deformable mirror, thermally-actuated deformable mirror, etc. Certain configurations may utilize two or more deformable mirrors (e.g. in tandem or in another configuration, etc.), in order to reduce the performance demand on a single deformable mirror.

Also in the context of the present description, the aforementioned optical aberrations refer to any situation where light destined for one point arrives at a different point. In different embodiments where the optical aberrations result from the telescope 102, the optical aberrations may include, but are certainly not limited to astigmatism aberrations, defocus aberrations, coma aberrations, trefoil aberrations, higher order aberrations, and/or any other similar aberrations, for that matter.

As mentioned above, the optical aberrations may result from the telescope 102. In various embodiments, the aberrations may result from an environment (e.g. gravity, temperature, etc.) of the telescope 102, for example. Of course, the optical aberrations may result, at least in part, from any aspect associated with the telescope 102. In the context of the present description, the aforementioned compensation refers to any reduction (at least in part) of the optical aberrations.

By this feature, any effect of such optical aberrations may be reduced for improving a quality of the optical signal that is received by an optical sensor 106. Such optical sensor 106 may include a photosensor (e.g. a single element signal detector, imager or an array detector acting as a wavefront sensor, etc.) or any sensor capable of sensing the optical signal. To this end, any optical aberrations resulting from the telescope 102 may be compensated for, utilizing the deformable mirror 104.

In one optional embodiment, this may permit use of a lower cost telescope 102 that still provides sufficient optical signal quality for a desired purpose (e.g. communication, medical including but not limited to ophtomology, laser imaging, laser remote sensing purposes, etc.). Of course, such compensation may also be beneficial with higher cost telescopes, as well as in the context of other purposes (e.g. imaging, etc.) to compensate for aberrations caused by thermal fluctuations and gravity sag as the telescope is articulated, etc.

As an option during use, the deformable mirror 104 may be under the control of logic 108 for adjusting the deformable mirror 104 to compensate for the optical aberrations. In one embodiment, such logic 108 may optionally receive input from the optical sensor 106, and thus serve as a feedback loop. In other embodiments, additional components may be employed to control the deformable mirror 104. Just by way of example, a signal detector or wavefront sensor (not shown), may be employed. Additional information regarding such optional embodiment will be set forth during the description of subsequent figures.

More illustrative information will now be set forth regarding various optional architectures and features of different embodiments with which the foregoing technique may or may not be implemented, per the desires of the user. It should be strongly noted that the following information is set forth for illustrative purposes and should not be construed as limiting in any manner. Any of the following features may be optionally incorporated with or without the other features described.

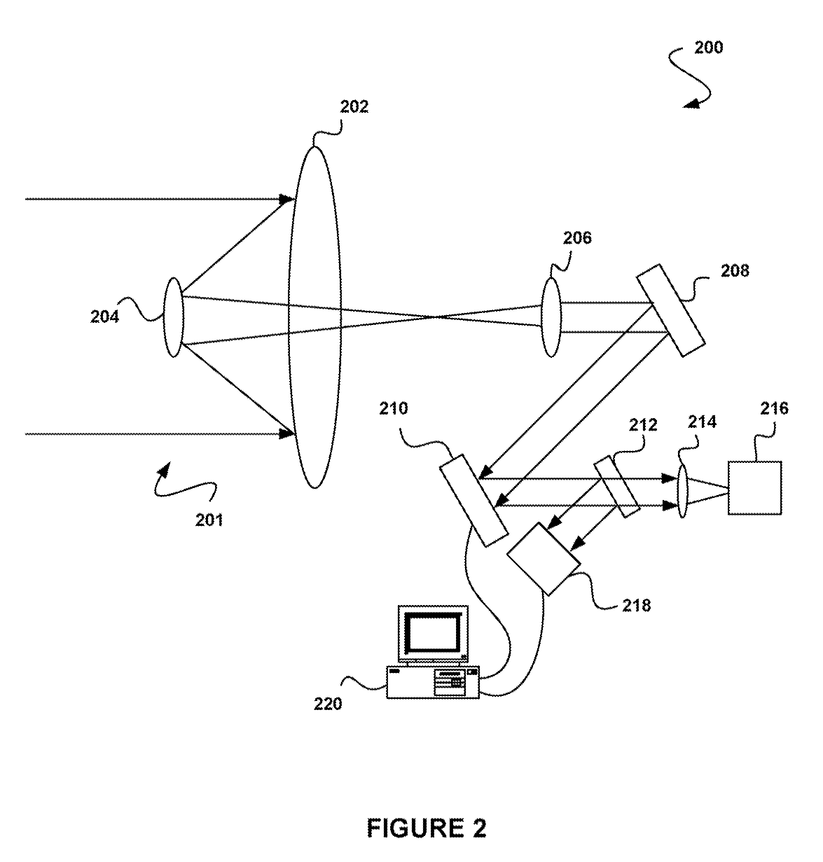

FIG. 2 illustrates a single telescope optical system 200 which may or may not include the various features set forth in the context of the optical system 100 of FIG. 1. Further, the definitions provided above may equally apply to the present description.

As shown in FIG. 2, a telescope 201 is included with a number of lenses 202, 204 for receiving optical signals. In one embodiment, such optical signals may include a laser beam that is received for communication purposes. For example, at least one aspect (e.g. amplitude, frequency, phase, etc.) of such laser beam may be encoded with data to be communicated. Of course, the optical signal may, in other embodiments, include other optical beams, etc. for any desired purpose (e.g. imaging, etc.).

Also provided is a beam-shaping lens/mirror 206 for receiving the optical signal from the telescope 201. In use, the beam-shaping lens/mirror 206 serves to shape a cross-section of the optical signal as desired. After such shaping, the optical signal is received by an optical element 208 that directs the optical signal to a deformable mirror 210.

In the present embodiment, a shape of the deformable mirror 210 is capable of being controlled with a speed that is appropriate for compensation of dynamic optical aberrations resulting from either of the optical elements 202, 204 of the telescope 201, and/or any other aspect associated with the telescope 201, for that matter.

In use, the deformable mirror 210 is operable to compensate for optical aberrations resulting from the telescope 210 (e.g. which may include aberrations resulting from auxiliary optics associated with the telescope 210, etc.). The deformable mirror 210 may, in some embodiments, compensate at intervals having a duration that exceeds the cause of the optical aberrations. In some embodiments, the interval may correspond to varying update rates. To this end, the deformable mirror 210 may be operable to compensate for atmospheric-induced aberrations, as well as optical aberrations.

In various embodiments, a period of a fraction of a minute to many minutes may elapse between changes being made to the deformable mirror 210 in order to compensate for optical aberrations. Thus, in some embodiments, the optical system 200 may include a low update rate (sub Hz to greater than 1 Hz) active optical system. Of course, other embodiments are contemplated where the present structure and functionality are capable of being implemented in an adaptive optical system, as well, where the deformable mirror is updated at a rate of sub-kHz to several kHz.

With continuing reference to FIG. 2, the compensated optical signal is shown to be directed to a beam splitter 212 for directing a first instance of the optical signal to mirror(s) 214 and an associated optical sensor 216. Such beam splitter 212 further directs a second instance of the optical signal to a wavefront sensor 218. The wavefront sensor 218 measures the optical aberrations to identify optical quality or lack thereof in the optical signal. In various embodiments, the wavefront sensor 218 may include, but is not limited to a Shack-Hartmann lenslet array.

Coupled between the wavefront sensor 218 and the deformable mirror 210 is a computing device 220. Such computing device 220 may, in various embodiments, include a computer workstation, an application-specific system, etc. that is capable of receiving a feedback signal from the wavefront sensor 218 that identifies any optical aberrations. The computing device 220 may, in turn, apply a specifically developed algorithm for controlling the deformable mirror 210 in a manner that compensates for the optical aberrations.

While the present embodiment employs a wavefront sensor 218, other embodiments are envisioned where such component is omitted. For example, feedback may be received from the optical sensor 216. In such varying embodiments, the aforementioned algorithm may be altered to accommodate the specific source (e.g. wavefront sensor, optical sensor, etc.) of the feedback signal.

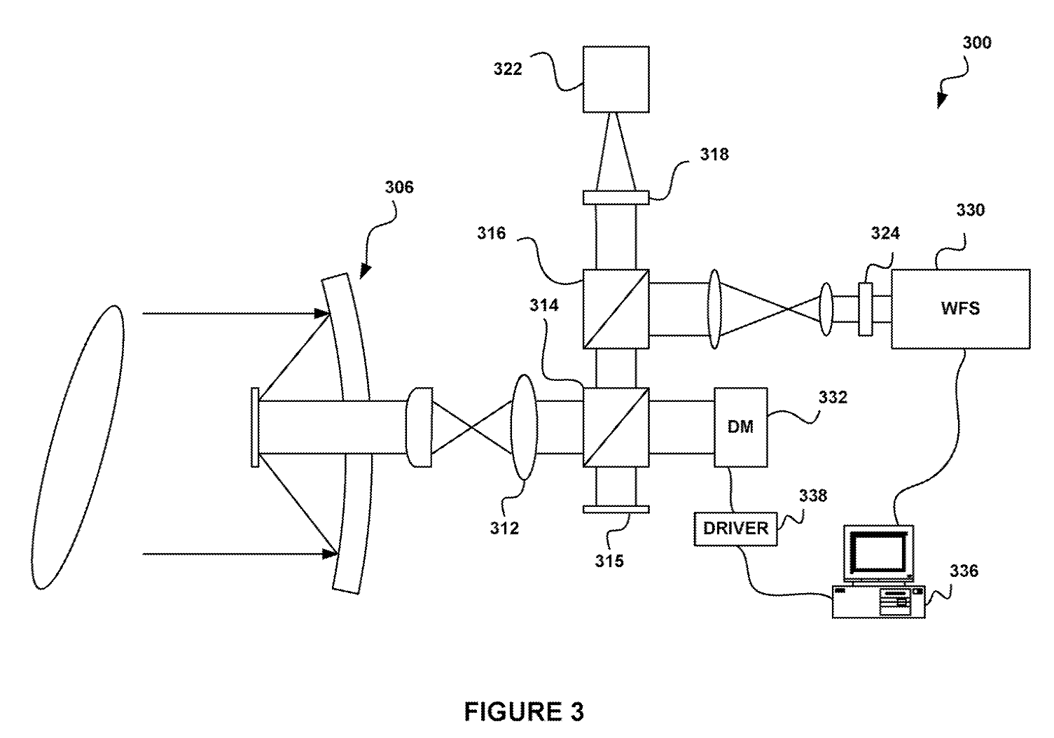

FIG. 3 illustrates a laboratory proof-of-concept setup 300 capable of compensating for optical aberrations, in accordance with yet another embodiment. As an option, the optical system 300 may or may not include the various features set forth in the context of the optical systems 100, 200 of FIGS. 1-2. Further, the definitions provided above may equally apply to the present description.

As shown, a telescope 306 is included for receiving an optical signal. Also provided are one or more refractive beam-shaping lenses 312 for receiving the optical signal from the telescope 306. Such beam-shaping lenses 312 may serve to reduce a beam diameter of the optical signal to one that is more suitable for the deformable mirror/wavefront active area, as will soon become apparent. A first beam splitter 314 to direct a first instance of the optical signal to a deformable mirror 332.

Further contemplated are various possible parameters of the deformable mirror 332 that may be subject to adjustment including, but not limited to number of degrees of freedom, actuator pitch, actuator stroke, direction of actuator movement, influence function, actuator coupling, response time, hysteresis and creep, etc. Just by way of example, the number of actuators used in conjunction with the deformable mirror 332 and the actuator stroke required for each element may depend on the extent of the optical aberrations to be corrected. For instance, while the speed of actuation may be less important in addressing any telescope-related optical aberrations, the actuator stroke (e.g. maximum possible actuator displacement, etc.) may need to be increased.

In the context of an embodiment involving polychromatic aberrations compensation with an optical system with ten waves of aberrations peak-to-valley (P-V) at a wavelength of 1-micrometer, about 5-micrometers of stroke in the deformable mirror 332 may be utilized. In another embodiment, the modulo 2pi technique (e.g. mono-chromatic compensation) may be employed (as opposed to the poly-chromatic technique), in order to reduce the required actuation from the individual actuators within the deformable mirror 332. In such case, for example, 1-micron of stroke from the mirror actuators will be adequate.

The first beam splitter 314 further directs a second instance of the optical signal (that has been subjected to the deformable mirror 332) to a second beam splitter 316. The second beam splitter 316 splits the incoming optical signal to direct a first instance of the optical signal to an optical sensor 322 via optical elements (e.g. lenses or curved and flat mirrors, filters etc.) 318 that serve to adjust a diameter of the optical signal, focus it, filter, attenuate the optical signal, etc. The second beam splitter 316 further directs a second instance of the optical signal to a wavefront sensor 330 via one or more optical elements 324, as shown.

Similar to the previous embodiment of FIG. 2, a computing device 336 is coupled between the wavefront sensor 330 and the deformable mirror 332 (possibly via a driver 338). The computing device 336 is adapted to apply a desired algorithm for controlling the deformable mirror 332 in a manner that compensates for the optical aberrations, based on a feedback signal from the wavefront sensor 330. As an option, a portion of a downlinked signal, a guidestar laser, natural star(s) within a field-of-view of the telescope 306, a far-field image of a planet (given sunlight pre-filtering during daytime), etc. may be utilized as a reference source for such wavefront sensor compensation.

Strictly as an option, the foregoing technique may be supplemented with other features for further compensating for telescope-related aberrations. For example, in some embodiments, primary and/or secondary mirrors of the telescope 306 may be directly and dynamically altered to compensate for telescope aberration. In other embodiments, dynamic real-time holography may be employed by utilizing liquid crystal spatial light modulators (SLMs). In the context of an embodiment that employs real-time holography, real-time holographic (diffractive wavefront control) feedback may be used in conjunction with the deformable mirror 332 for compensation of static and dynamic disturbances to the telescope optics.

As mentioned earlier, various applications are contemplated in the context different embodiments. For example, it is contemplated that the various techniques disclosed herein may be employed in connection with laser radar, laser remote sensing, imaging, communication purposes, etc. Of course, applications are also contemplated for use with optical signals other than lasers.

In terms of communication systems that receive optical communication signals over a long distance (e.g. from outer space, etc.), inexpensive telescopes may be employed with non-diffraction-limited quality optical apertures and effective aperture diameters in the order of several meters to tens of meters. In some embodiments, resultant optical systems that exhibit an overall wavefront error of up to twenty times greater than the diffraction limit (e.g. about 1-wave at 1000 nm) are tolerable. By incorporating a deformable mirror, the slowly varying surface wavefront error (WFE) of low-quality multimeter-diameter mirrors may be reduced from approximately 10's to 100's of waves peak-to-valley (P-V), at a 1000-nanometer wavelength, to approximately one wave or less (in some embodiments).

For example, in the case of a smaller telescope (e.g. 0.3 meter telescope) that is utilized at a wavelength of 633 nanometers, root means square (RMS) WFE was improved to 0.05 waves (0.26 waves P-V) from an original value of 1.4 waves RMS 6.5 waves P-V). Further, in such embodiment, the Strehl ratio was improved to 89% from an original value of 0.08%.

To this end, various embodiments are disclosed for providing an optical system employing a deformable mirror that can significantly compensate for wavefront aberrations of a low-cost telescope arising from mirror quality and/or external factors. Thus, a cost effective implementation of active optical compensation techniques may be applied to multimeter-diameter-size optics for allowing the rapid fabrication of an affordable high-quality optical system with dynamic compensation of the system as the thermal and mechanical environments affect it.

The foregoing description has set forth only a few of the many possible implementations. For this reason, this detailed description is intended by way of illustration, and not by way of limitations. Variations and modifications of the embodiments disclosed herein may be made based on the description set forth herein, without departing from the scope and spirit of the present application.

It is only the following claims, including all equivalents, that are intended to define the scope of the various embodiments. Moreover, the embodiments described above are specifically contemplated to be used alone as well as in various combinations. Accordingly, other embodiments, variations, and improvements not described herein are not necessarily excluded.

What is claimed is:

1. An optical system, comprising:
at least one telescope; and
a deformable mirror operable to compensate for optical aberrations resulting from the telescope.

2. The optical system of claim 1, wherein a plurality of the deformable mirrors are included for compensating for the optical aberrations resulting from the telescope.

3. The optical system of claim 1, and further comprising a single or multi-element optical sensor for receiving an optical signal via the deformable mirror.

4. The optical system of claim 3, wherein the deformable mirror is controlled utilizing a feedback signal received form a single- or multi-element optical sensor.

5. The optical system of claim 1, wherein the deformable mirror is controlled utilizing a feedback signal received from a wavefront sensor.

6. The optical system of claim 1, wherein the deformable mirror is operable to compensate for the optical aberrations resulting from the telescope at intervals corresponding to varying update rates.

7. The optical system of claim 1, wherein a plurality of the telescopes are included, and the deformable mirror is operable to compensate for the optical aberrations resulting from the plurality of telescopes.

8. The optical system of claim 1, wherein the optical aberrations resulting from the telescope are selected from the group consisting of astigmatism aberrations, defocus aberrations, coma aberrations, trefoil aberrations, and higher order aberrations.

9. The optical system of claim 1, wherein the optical system is utilized for communication, medical, laser radar, laser imaging, or laser remote sensing purposes.

10. The optical system of claim 1, wherein a beacon signal enters the telescope.

11. The optical system of claim 10, wherein the beacon signal includes at least one of a portion of a communications signal, an artificially generated guide star, light from a star within a field of view of the telescope, light from a planet, and an artificial signal placed outside the telescope such that light generated by the artificial signal propagates through the telescope.

12. The optical system of claim 1, wherein the compensation includes a monochromatic compensation technique.

13. The optical system of claim 1, wherein the compensation includes a polychromatic compensation technique.

14. The optical system of claim 1, wherein the compensation includes a dynamic holography technique.

15. The optical system of claim 1, wherein the deformable mirror has a surface selected from the group consisting of a continuous surface and a segmented surface.

16. The optical system of claim 1, wherein the deformable mirror is actuated utilizing a technique selected from the group consisting of a piezoelectric technique, a micro-machined technique, a liquid crystal-related technique, a microelectromechanical system (MEMS) technique, and a thermal technique.

17. The optical system of claim 1, wherein one or more spatial modulators are included for compensating for the optical aberrations resulting from the telescope.

18. A method, comprising:
receiving a signal utilizing a system;
directing the received signal to a deformable mirror; and
compensating for aberrations resulting from the system, utilizing the deformable mirror.

19. The method of claim 18, wherein the signal includes one or more an optical frequency signal, an ultraviolet frequency signal, a near or far infrared frequency signal, a terahertz frequency signal, a millimeter-wave frequency signal, and a microwave frequency signal.

20. An apparatus, comprising:
a system; and
a deformable mirror operable to compensate for aberrations resulting from the system.
